(19) United States
(12) Patent Application Publication
(10) Pub. No.: US 2013/0243079 A1
(43) Pub. Date: Sep. 19, 2013

(54) STORAGE AND PROCESSING SAVINGS WHEN ADAPTING VIDEO BIT RATE TO LINK SPEED

(71) Applicants: John HARRIS, Glenview, IL (US); Gerald Gutowski, Glenview, IL (US); Greg Nemec, Johnsburg, IL (US)

(72) Inventors: John HARRIS, Glenview, IL (US); Gerald Gutowski, Glenview, IL (US); Greg Nemec, Johnsburg, IL (US)

(73) Assignee: Nokia Siemens Networks Oy

(21) Appl. No.: 13/423,433

(22) Filed: Mar. 19, 2012

(51) Int. Cl. H04N 7/26

(52) U.S. Cl. 375/240.02; 375/E07.154

(57) ABSTRACT

A method includes creating a video stream using alternating portions of video from at least two previously compressed files of similar video content having one or both of differing bit rates or dimensional qualities. The video stream is created to have a bit rate that is intermediate bit rates of the at least two previously compressed files. The intermediate bit rate is based on one or more estimates of a wireless link speed over a wireless channel between a user equipment and a network. The method includes outputting the created video stream. Apparatus and program products are also disclosed.

### TECHNICAL FIELD

This invention relates generally to networks and, more specifically, relates to the delivery of video to user equipment (UE) in wireless communication with a radio access network.

### BACKGROUND

This section is intended to provide a background or context to the invention disclosed below. The description herein may include concepts that could be pursued, but are not necessarily ones that have been previously conceived, implemented or described. Therefore, unless otherwise explicitly indicated herein, what is described in this section is not prior art to the description in this application and is not admitted to be prior art by inclusion in this section.

The following abbreviations that may be found in the specification and/or the drawing figures are defined as follows:
2-D two dimensional
3-D three dimensional
ALS Apple live stream
AWT alternate wireless technology
BTS base transceiver station
CAN-EG content aware network-enabling gateway
CDN content delivery network
CN core network
eNode B (eNB) evolved Node B (LTE base station)
E-UTRAN evolved UTRAN
GGSN gateway GPRS support node
GOP group of pictures
GPRS general packet radio service
GPS global positioning system
GTP GPRS tunneling protocol
HLR home location register
HO handover
HSS home subscriber server
HTTP hypertext transfer protocol
LTE long term evolution
Node B (NB) Node B (base station in UTRAN)
MME mobility management entity
MO media optimizer
MSS Microsoft smooth stream
MVC multiview video coding
NBG NSN browsing gateway
NHV next higher value
NLV next lower value
NSN Nokia Siemens Networks
PC preferred compression
PCRF policy control and charging rules function
PDN-GW packet data network-gateway
RAN radio access network
RNC radio network controller
SGSN serving GPRS support node
UE user equipment
UMTS universal mobile telecommunications system
URL uniform resource locator
UTRAN universal terrestrial radio access network

Adaptive streaming provides powerful techniques for significantly increasing system capacity and video quality. However, when selecting among pre-compressed versions of video such as Netflix, Microsoft smooth stream (MSS), or Apple live stream (ALS), additional video quality degradation can result when a pre-compressed version of video is selected that has a closest bit rate that will fit over the wireless link, as this version may have more compression than is necessary. Furthermore, manually decompressing and recompressing files (e.g., to create video having bit rates between two pre-compressed versions of video in order to exactly fit over the wireless link) is extremely processing intensive. For instance, some systems sold for this purpose cost about 100,000 U.S. dollars and can optimize about 1000 video streams at a time. Even if manual decompression and recompression is used, storing video with different compression levels in addition to a number of pre-compressed videos results in significantly greater storage requirements and costs.

Additionally, with manual decompression/recompression, a network must make a decision on the appropriate compression level well in advance of a mobile device's downloading the video. Often, this is not possible because channel conditions change too rapidly to estimate the conditions that much in advance. Further, changes to the level of video compression typically occur only once per epoch (e.g., 2, 5 or 10 second intervals, depending on the video streaming software being used). Thus, compression level is determined prior to the download for the epoch.

### SUMMARY

This Summary is meant to be exemplary and illustrates possible examples of implementations.

In an example, a method includes creating a video stream using alternating portions of video from at least two previously compressed files of similar video content having one or both of differing bit rates or dimensional qualities. The video stream is created to have a bit rate that is intermediate bit rates of the at least two previously compressed files. The intermediate bit rate is based on one or more estimates of a wireless link speed over a wireless channel between a user equipment and a network. The method includes outputting the created video stream.

In another example, and apparatus is disclosed that includes: means for creating a video stream using alternating portions of video from at least two previously compressed files of similar video content having one or both of differing bit rates or dimensional qualities. The video stream is created to have a bit rate that is intermediate bit rates of the at least two previously compressed files. The intermediate bit rate is based on one or more estimates of a wireless link speed over a wireless channel between a user equipment and a network. The apparatus includes means for outputting the created video stream.

In another example, a computer program product is disclosed that includes a computer-readable storage medium bearing computer program code embodied therein for use with a computer. The computer program code includes: code for creating a video stream using alternating portions of video from at least two previously compressed files of similar video content having one or both of differing bit rates or dimensional qualities, the video stream created to have a bit rate that is intermediate bit rates of the at least two previously compressed files, the intermediate bit rate based on one or more estimates of a wireless link speed over a wireless channel between a user equipment and a network; and code for outputting the created video stream.

In a further example, an apparatus includes one or more processors and one or more memories including computer program code. The one or more memories and the computer program code are configured, with the one or more processors, to cause the apparatus to perform at least the following: creating a video stream using alternating portions of video from at least two previously compressed files of similar video content having one or both of differing bit rates or dimensional qualities, the video stream created to have a bit rate that is intermediate bit rates of the at least two previously compressed files, the intermediate bit rate based on one or more estimates of a wireless link speed over a wireless channel between a user equipment and a network; and outputting the created video stream.

### BRIEF DESCRIPTION OF THE DRAWINGS

In the attached Drawing Figures:

FIG. 1 illustrates a block diagram of an exemplary system in which the instant invention may be used;

FIG. 2 illustrates a block diagram of another exemplary system in which the instant invention may be used;

FIG. 3 illustrates a block diagram of an exemplary computer system suitable for implementing embodiments of the instant invention;

FIG. 4 illustrates a diagram of two video streams, one created with conventional techniques and another created with an exemplary embodiment of the instant invention;

FIGS. 5 to 7 are block diagrams of exemplary system interactions using convention techniques and using exemplary embodiments of the instant invention;

FIG. 8 is a block diagram of a flowchart performed by one or more elements in an operator network for storage and processing savings when adapting video bit rate to link speed;

FIG. 9 is a more specific example of a portion of FIG. 8;

FIG. 10 is another example of the flowchart of FIG. 8; and

FIG. 11 is an example of a mechanism suitable to use for alternating between two different files with two different bit rates.

### DETAILED DESCRIPTION OF THE DRAWINGS

There are certain problems with adapting video bit rate to link speed. These problems will be described in more detail, once overviews of systems into which the invention may be used are described.

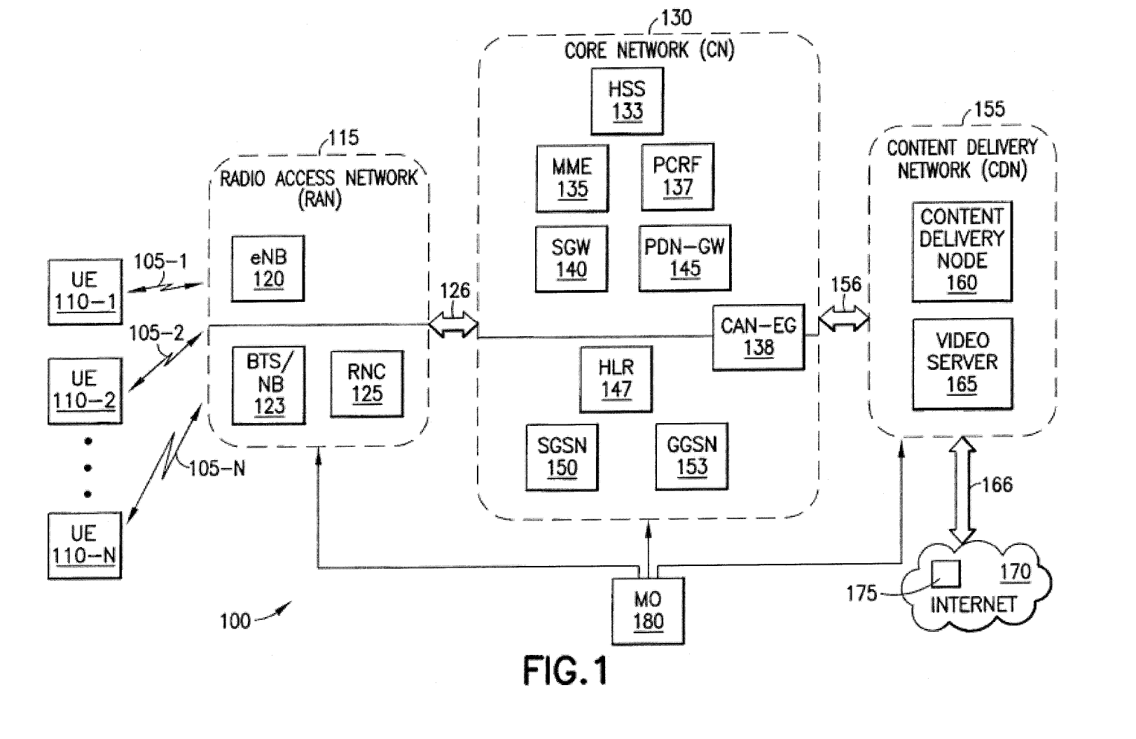

Turning now to FIG. 1, this figure illustrates a block diagram of an exemplary system into which the instant invention may be used. FIG. 1 is an example of a video server—RAN interfaced architecture for, e.g., a macro cell. The architecture shows N user equipment 110-1 through 110-N communicating via a corresponding wireless link 105-1 through 105-N (including uplink and downlink) to a network 100. Uplink and downlink communication may occur over one or more wireless channel, as is known. The network 100 includes a RAN 115, a core network (CN) 130, and a content delivery network (CDN) 155. The CDN 155 is connected to the Internet 170 via one or more links 166. The RAN 115 is connected to the CN 130 via one or more links 126. The CN 130 is connected to the CDN 155 via one or more links 156.

In an E-UTRAN embodiment, the RAN 115 includes an eNB (evolved Node B, also called E-UTRAN Node B) 120, and the CN 130 includes a home subscriber server (HSS) 133, a serving gateway (SGW) 140, a mobility management entity (MME) 135, a policy and charging rules function (PCRF) 137, and a packet data network gateway (PDN-GW) 145. E-UTRAN is also called long term evolution (LTE). The one or more links 126 may implement an S1 interface.

In a UTRAN embodiment, the RAN 115 includes a base transfer station (BTS) (Node B) 123, and a radio network controller 125, and the CN 130 includes a serving GPRS support node (SGSN) 150, a home location register (HLR) 147, and a gateway GPRS support node (GGSN) 153. The one or more links 126 may implement an Iu interface.

The CAN-EG 138 may be part of either EUTRAN or UTRAN and is a network entity that enables the alignment of the network resources (such as bandwidth required, Quality of Service, type of bearer (best-effort, guaranteed, non-guaranteed, dedicated)), with the needs of the service and alignment of these resources throughout a session.

The CDN 155 includes a content delivery node 160 and a video server 165, which may also be combined into one single node. The content delivery node 160 may provide a cache of information on the Internet 170. The video server 165 may provide a cache of video, e.g., at different compression rates and/or resolutions.

The examples above indicate some possible elements within the RAN 115, CN 130, and CDN 155 but are not exhaustive, nor are the shown elements necessary for the particular embodiments. Furthermore, the instant invention may be used in other systems, such as CDMA (code division multiple access) and LTE-A (LTE-advanced).

In this example, one or more of the user equipment 110 connect to the content source 175 in the Internet 170 to download video via, e.g., a service entity such as a media optimizer (MO) 180, content delivery node 160 or video server 165. The video server 165 in this example is a cache video server, meaning that the video server 165 has a cached copy of video stored on the content source 175. The content source 175 may be an origin server, which means the content source 175 is the original video source (e.g., as opposed to a video server 165 having cached content). The MO 180 may be implemented in the RAN 115, the CN 130, and/or the CDN 155. Optimized content is streamed from the MO 180 or video server 165 to the PDN-GW 145/GGSN 153, which forwards the content to the SGW 140/SGSN 150 and finally through the eNodeB 120/NB 123 to the UE 110. If the video server(s) 165 are used, the servers are considered surrogate servers, since these servers 165 contain cached copies of the videos in content sources 175.

The video contained in one or more video streams between elements in the wireless network 100 is carried over the wireless network 100 using, e.g., hypertext markup language (HTML). The videos are requested by user equipment 110 through a series of separate uniform resource locators (URLs), each URL corresponding to a different video stream of the one or more video streams.

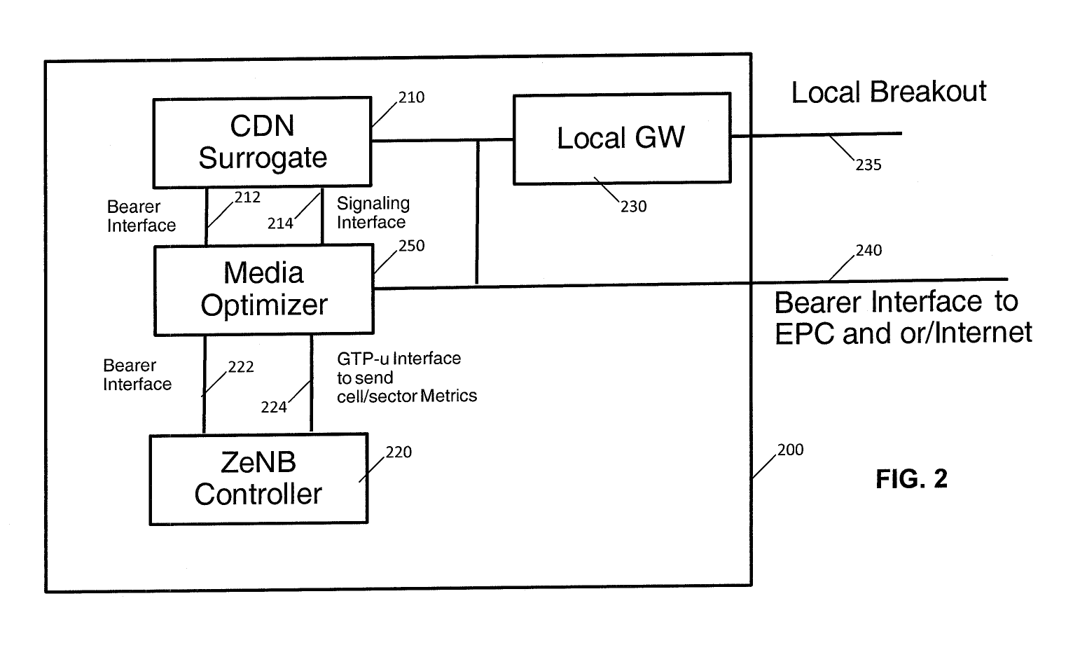

Referring to FIG. 2, this figure illustrates a block diagram of another exemplary system in which the instant invention may be used. This is an example of applicability to “small” cell architectures, such as pico or femto cells. In this example, the system 200 is located near or coincident with a cell phone tower. The system 200 includes a “zone” eNB (ZeNB) controller 220, a media optimizer 250, a content delivery network (CDN) surrogate 210, and a local gateway (GW) 230. The ZeNB controller 220 controls multiple eNodeBs (not shown in FIG. 2) and communicates with the media optimizer 250 using, in this example, a bearer interface 222 and a GTP-u interface 224. The GTP-u interface 224 allows the ZeNB controller 220 to send cell/sector metrics to the media optimizer 250 and allows the ZeNB controller 220 to receive requests from the media optimizer 250. Such metrics provide the media optimizer 250 an indication of the state of the cell/sector that the media optimizer 250 uses to determine the parameters for video optimization.

The media optimizer 250 communicates in this example with a CDN surrogate 210 via a bearer interface 212 and a signaling interface 214. The CDN surrogate 210 acts as a local cache of content such as video. The CDN surrogate 210 communicates with a bearer interface 240 (as does the media optimizer 250) to the evolved packet core (EPC), the Internet, or both. The local gateway 230 also communicates via a network 235 providing a local breakout of bearer traffic to the network instead of routing the bearer traffic over the wireless network via interface 240.

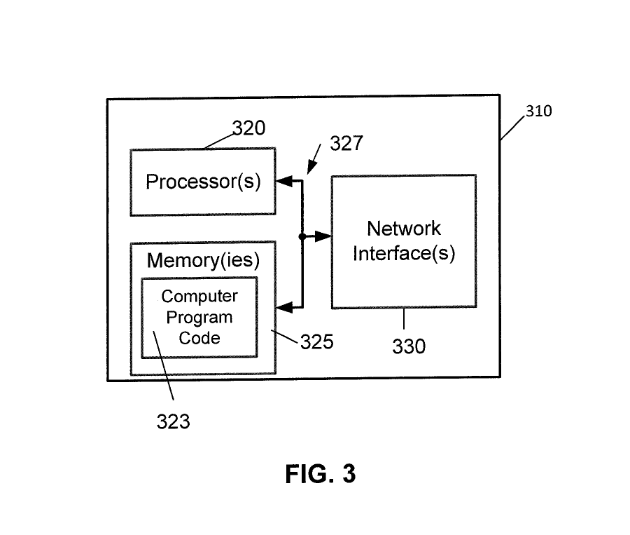

Turning now to FIG. 3, this figure illustrates a block diagram of an exemplary computer system suitable for implementing embodiments of the instant invention. The exemplary embodiments may involve multiple entities in the network 100, such as the media optimizer 150, the PDN-GW 135, the eNodeB 120, the CDN surrogate 210, the video servers 160, the content sources 160, and/or the CAN-EG 145. Each one of these entities may include the computer system 310 shown in FIG. 3. Computer system 310 comprises one or more processors 320, one or more memories 325, and one or more network interfaces 330 connected via one or more buses 327. The one or more memories 325 include computer program code 323. The one or more memories 325 and the computer program code 323 are configured to, with the one or more processors 320, cause the computer system 310 (and thereby a corresponding one of, e.g., the media optimizer 150, the PDN-GW 135, the eNodeB 120, the CDN surrogate 210, the video servers 160, the content sources 160, and/or the CAN-EG 145) to perform one or more of the operations described herein.

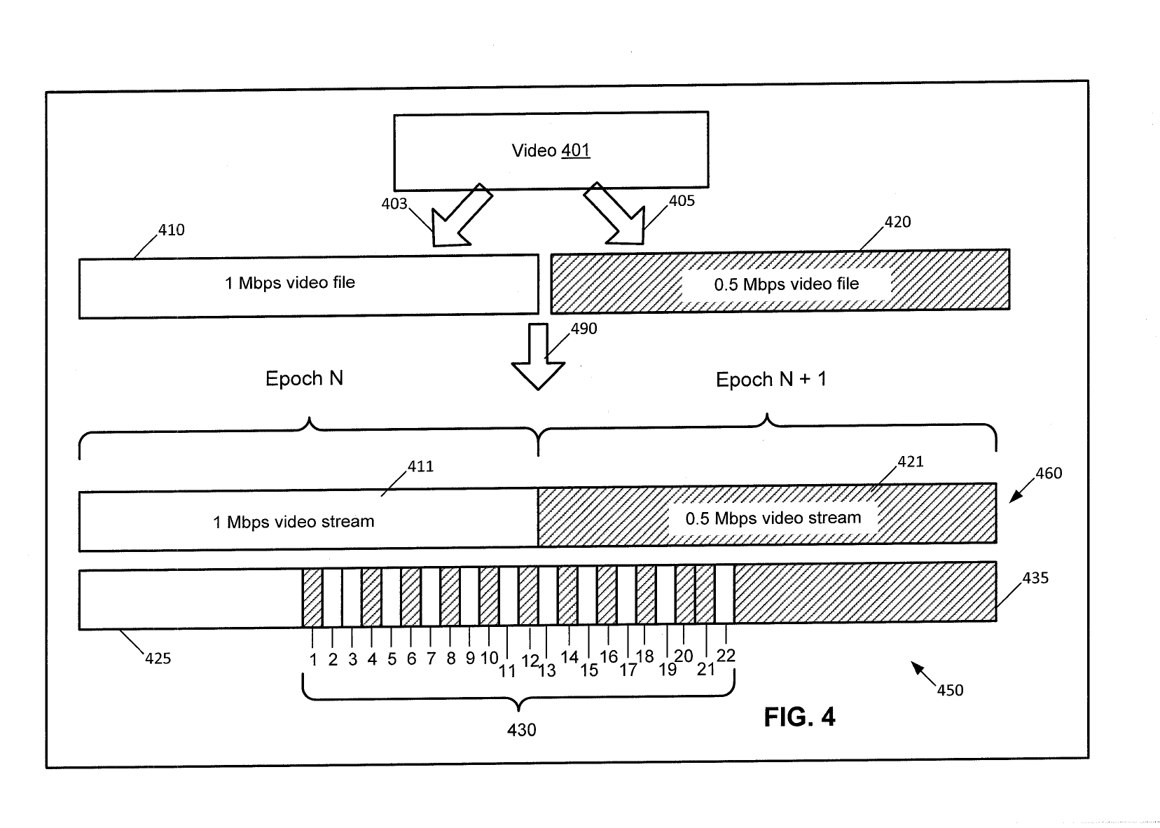

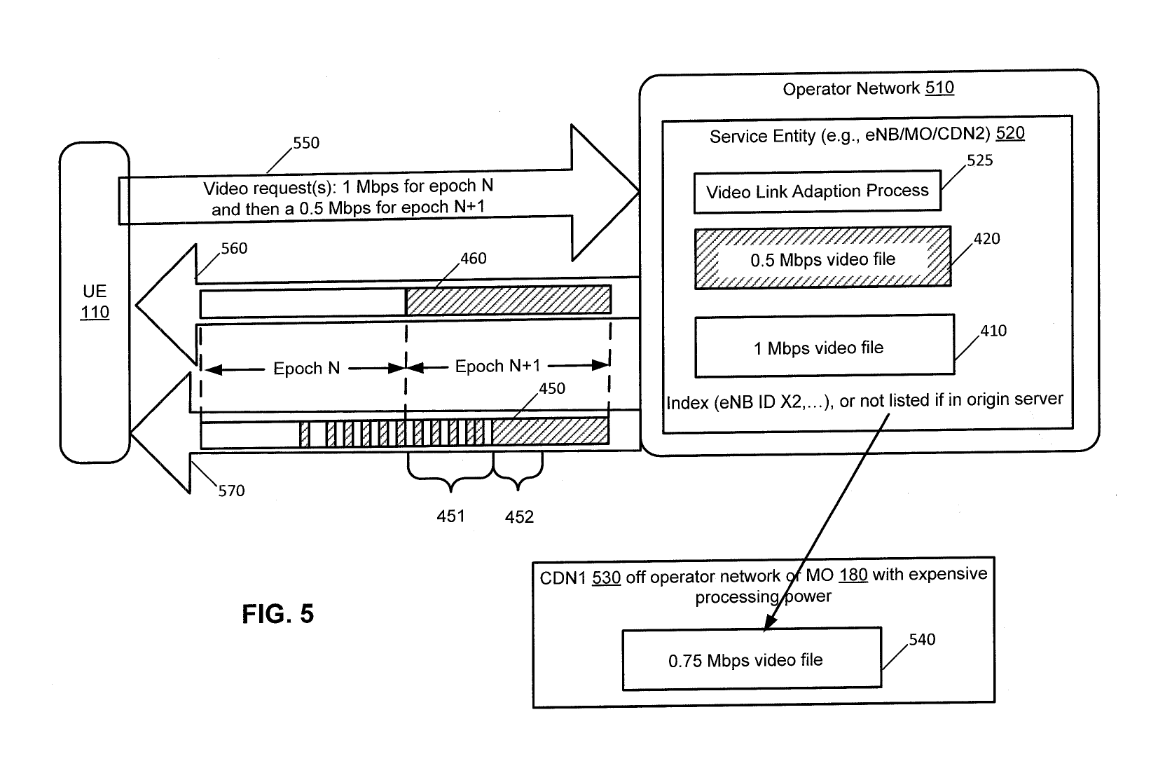

As described above, there are times when estimated channel conditions from a network to a user equipment do not provide an “exact fit” with a selection of video available at the network. For instance, FIG. 4 illustrates a diagram of two video streams, one video stream 460 created with conventional techniques and another video stream 450 created with an exemplary embodiment of the instant invention. FIG. 4 provides an overview of exemplary embodiments of the instant invention, and is also described in more detail with reference to FIG. 5. In terms of this example, a single video 401 is operated on by a compression process 403 to determine a 1 Mbps video file 410 and is operated on by a compression process 405 to determine a 0.5 Mbps video file 420. Therefore, each video file 410, 420 in an exemplary embodiment is created using the same video 401 but has a different bit rate. The processes 403, 405 occur before an entity (e.g., eNB 120, MO 180) in the network 100 will use the files 410, 420 to create (process 490) a video stream to a user equipment 110. In other words, the entity has access to the files 410, 420, but typically does not perform the compression processes 403, 405.

An important consideration useful in certain embodiments herein is that in certain cases, the files 410, 420 may contain similar video but may not contain compressed versions of exactly the same video. A Joint Video Team of the ITU-T Video Coding Experts Group (VCEG) and the ISO/IEC Moving Picture Experts Group (MPEG) has also standardized an extension of the H.264/MPEG-4 Advanced Video Coding (AVC). This extension is referred to as multiview video coding (MVC). MVC provides a compact representation for multiple views of a video scene, such as multiple synchronized video cameras. Stereo-paired video for 3-D viewing is an important special case of MVC. Regarding MVC, see Vetro, et al., “Overview of the Stereo and Multiview Video Coding Extensions of the H.264/MPEG-4 AVC Standard”, Proceeding of the IEEE, Vol. 99, Issue 4, pp. 626-642 (2011). Thus, there could be two views in video 410, each of which is one view of a single scene, in order to create a 3-D video. If the video 410 is 3-D, this version therefore could contain a compressed version of both (or multiple) views of single scenes from video 401. If the video 420 is 2-D, this version therefore could contain a compressed version of a single one of the two views of single scenes from video 401.

The creation process 490 selects GOPs from each of the 1 Mbps video file 410 or the 0.5 Mbps video file 420. That is, for epoch N, a user equipment (not shown in this figure) requests (e.g., reports) to the network that the channel conditions are such that a 1 (one) Mbps (mega bits per second) video stream can be supported and requests (e.g., reports) to the network at epoch N+1 that the channel conditions are such at a 0.5 Mbps video stream can be supported.

Currently, MOs and self-optimizing video protocols like Apple Live Stream (ALS) and Microsoft Smooth Stream (MSS) function on an epoch basis, i.e., media adjustment every “x” seconds and either send only an “x” second portion of video or a steady stream of video with modifications every “x” seconds. For instance, an epoch for ALS is 10 seconds, a typical MO has an epoch of three or five seconds, and an epoch for MSS is two seconds. Therefore, an epoch is some time period during which the video bit rate typically does not change.

In one embodiment, using Apple Live Stream (and this example may also apply to other adaptive streaming protocols) the UE requests a separate URL (e.g., corresponding to a file) for each section of the video. A number of different URLs corresponding to different compression levels are available, and the UE chooses one of the URLs which matches the most appropriate compression level. Alternatively with a media optimizer, the media optimizer element estimates the link speed directly by monitoring, e.g., the rate of TCP/IP acknowledgments received, and generates an estimate of the appropriate compression level shortly before the next epoch boundary. Using a conventional system, the video stream 460 produced would be a 1 (one) Mbps video file portion 410 in epoch N and a 0.5 Mbps video file portion 420 in epoch N+1. This decrease happens basically instantaneously (e.g., at the epoch boundary between epochs N and N+1), which may be noticeable.

Exemplary embodiments of the instant techniques, however, enable better matching of video compression level to communication channel link speed, e.g., with significantly reduced storage requirements and processing requirements. These exemplary embodiments may include providing a video with a bit rate in between the bit rates of two different previously compressed files of the same video content. The video, in an exemplary embodiment, comprises alternating video GOPs (group of pictures) between video of next higher and next lower bit rates (from two different bit rate video files of the same video) which are available and spliced together to create an intermediate bit rate in between the two different previously compressed versions of the same video file. This “feathering” of video between multiple bit rates and typically within some portion of an epoch provides the video stream with an intermediate bit rate. Regarding GOPs, frames of video can be grouped into sequences called a group of pictures (GOP). A GOP is an encoding of a sequence of frames that contains all the information that can be completely decoded within that GOP. For all frames within a GOP that reference other frames (such as B-frames and P-frames), the frames so referenced (I-frames and P-frames) are also included within that same GOP. The types of frames and their location within a GOP can be defined in a time sequence. The temporal distance of images is the time or number of images between specific types of images in a digital video. M is the distance between successive P-Frames and N is the distance between successive I-Frames. Typical values for MPEG (motion picture experts group) GOP are M equals 3 and N equals 12. Concerning the number of GOPs per time period, in one non-limiting embodiment, there is an I frame or a start of a GOP once every 12 frames, where there are 30 frames per second. In this case, there is one frame every 33.33 ms=1000/30, and there is a new GOP every 400 ms, e.g. 400=12×33.33.

As explained above, a UE 110 needs to generate an estimate of wireless link speed prior to downloading the next section of video. When the estimate of wireless link speed is basically embedded in the request for the next section (as the request for the next section is effectively a request for a certain bit rate), this can apply to exemplary embodiments herein, as the next section is often requested before the previous section has completed downloading. An entity (e.g., a service entity serving the video) in an operator network can identify the requested section and make an estimate of the wireless link speed and perform the embodiments described herein. Alternatively, the service entity can use knowledge of what was the bit rate of the previous section and then the entity can perform the blending of alternating GOPs at the beginning of the video stream for the next section (e.g., epoch) of video, beginning by alternating in more GOPs set at the previous bit rate (from the higher bit rate file) and then alternating in GOPs from the lower bit rate file and less frequently.

Additionally, an alternating pattern may be only used, in an exemplary embodiment, if there is more than a threshold difference between a preferred compression level (e.g., bit rate or dimensional qualities of the video, e.g., 3-D/2-D status) and one of the following: (1) the bit rates available for the two different compressed video files, or (2) the bit rate or 3-D/2-D status being provided to the current epoch/time interval relative to the bit rate or 3-D/2-D status to be provided in the next time interval. In another exemplary embodiment, the alternating pattern may be based on the targeted compression level bit rate, called the preferred compression (PC) level bit rate. Further, the alternating pattern may be based on the next lower value (NLV) of compression available being greater than the PC level. Additionally, the alternating pattern may be based on the next higher value (NHV) of compression available being less than the PC level.

As a further exemplary embodiment, the alternating pattern may comprise [(PC-NLV)/(NHV-NLV)] percent of the GOPs from the NHV stream and 1−[(PC-NLV)/(NHV-NLV)] from the NLV stream. The rate of change of this percentage (e.g., from 100 percent from NHV to 50% NHV and 50% NLV) is limited in an exemplary embodiment in order to enable a gradual change in video quality.

The limiting in this case would be that the mechanism would have a maximum rate at which the average bit rate can change. An example of this follows. Assume all of the GOPs are numbered. The number of each GOP is one more than the immediately prior GOP. Pick an arbitrary point in the middle of the video, at the k^{th} GOP. The next N GOPs number k+1 through K+N Immediately subsequent to the (k+N)^{th} GOP, is another group of N GOPs which are numbered k+N+1 through k+N+N (or k+2N). Using this terminology, a service entity can parameterize and control the rate at which the compression level (e.g., bit rate) of the video changes such that the service entity requires (in an example) that, for any value of K, the average bit rate provided in the GOPs numbered between k+N+1 and k+2N is less than (1+Y) multiplied by (the average bit rate provided in the GOPs numbered between k+1 and k+N) and is greater than (1/(1+Z)) multiplied by (the average bit rate provided in the GOPs numbered between k+1 and k+N). In an example, Z=Y=0.2 and N=5. This is only one example and other techniques may be used.

Applying an exemplary embodiment of the instant invention to the creation process 490 to create video stream 450, therefore, this video stream starts at 1 Mbps in portion 425, nearest the beginning of epoch N, and the video in this portion of the stream 450 comes from file 410. The video stream 450 ends at 0.5 Mbps (portion 435), nearest the end of epoch N+1, and this part of the video stream 450 comes from file 420. Instead of a simple transition at the epoch boundary from 1 Mbps to 0.5 Mbps, video stream 450 has an alternating pattern 430 that contains GOPs 1 to 22. GOPs 1, 4, 6, 8, 10, 12, 14, 16, 18, 10, and 21 are from the 0.5 Mbps video file 420, and GOPs 2, 3, 5, 7, 9, 11, 13, 15, 17, 19, and 22 are from the 1 Mbps video file 410. It is noted that the “alternating” pattern 430 may not be strictly alternating in the sense that each GOP from one of the files is followed by a GOP from another one of the files. For instance, the GOPs 2 and 3 are from the 1 Mbps video file 410, and therefore there is some portion of the pattern 430 where there are more GOPs from one file 410/420 than from the other file 420/410. However, there may also be portions (e.g., as from GOPs 4 through 19) where the GOPs do strictly alternate between files 410/420.

Using the previous equations as examples, in an exemplary embodiment, the percentage of GOPs from the NHV steam (e.g., 1 Mbps video file 410) is [(0.75-0.5)/(1.0-0.5)], or 0.5 (or 50%, if expressed as percentage), where the PC bit rate is 0.75 Mbps, the NLV bit rate is 0.5 Mbps, and the NHV bit rate is 1 Mbps. The percentage of GOPs from the NLV stream (e.g., 0.5 Mbps file 420) is 1-0.5, or 0.5 (or 50%, if expressed as percentage).

In one example, the higher bit rate (1 Mbps video stream 411 or stream 425 and GOPs 2, 3, 5, 7, 9, 11, 13, 15, 17, 19, and 22) could be a 3-D video stream, while the lower bit rate (0.5 Mbps video stream 421 or GOPs 1, 4, 6, 8, 10, 12, 14, 16, 18, 10, and 21) could be a 2-D video stream. As an example, the 3-D video stream could be a MVC, multiview video coding, stream, and here exemplary embodiments of the instant invention contemplate any MVC profile, including base (backwards compatible with 2-D viewing), high, or constrained profiles, all to be treated without prejudice according to the exemplary techniques of this invention, and the 2-D video stream could be a standard (e.g., non-MVC) 2-D video stream. Furthermore, the alternating pattern techniques herein may also apply to 3-D to 2-D transitions in MVC. Regarding MVC, see Vetro, et al., “Overview of the Stereo and Multiview Video Coding Extensions of the H.264/MPEG-4 AVC Standard”, Proceeding of the IEEE, Vol. 99, Issue 4, pp. 626-642 (2011).

Turning now to FIG. 5, a block diagram is shown of exemplary system interactions using convention techniques and using an exemplary embodiment of the instant invention. FIG. 5 uses an example similar to the example in FIG. 4. In FIG. 5, a UE 110 is in wireless communication with an operator network 510, which includes the RAN 115, CN 130, and CDN 155 in this example. The operator network can include a service entity 520, including one or more of the eNB 120 (see FIG. 1), the MO 180 (see FIG. 1), or a second CDN 155 (“CDN2”). The service entity 520 is not limited to these entities and may also include, e.g., a video server or NBG (NSN browsing gateway). A service entity 520, particularly a MO 180, may use corresponding video protocols used to optimize video downloading and may provide powerful techniques for significantly increasing system capacity and video quality.

There is a video link adaptation process 525 that operates to perform operations as described herein. The video link adaptation process 525 may be situated on the service entity 520, e.g., one of the eNB 120, the MO 180, or a second CDN2 155, or spread over these elements. The video link adaptation process 525 may be implemented via computer program code 323 in the memories 325 and executed by the processors 320, may be implemented via hardware (e.g., using an integrated circuit configured to perform one or more operations), or some combination of these.

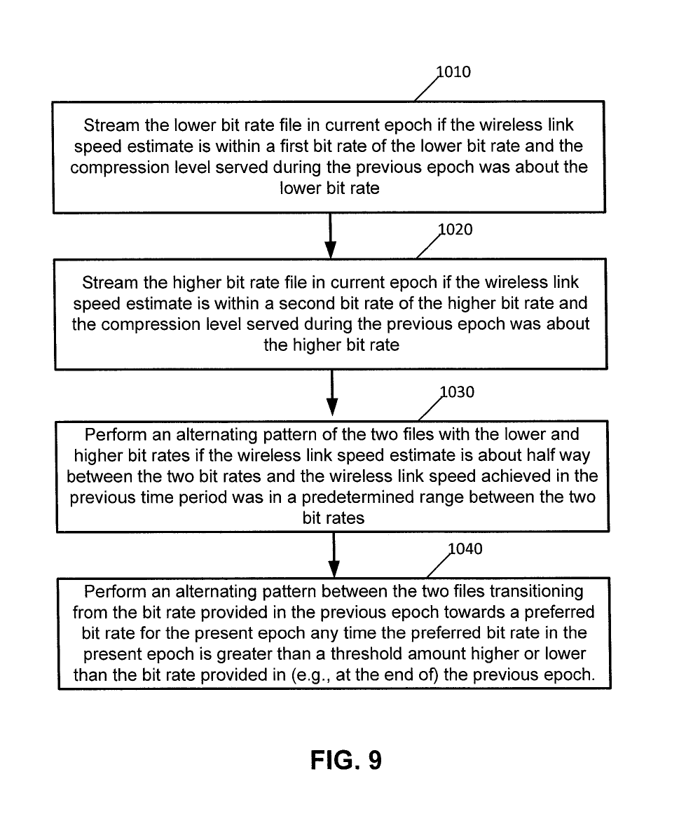

The service entity 520 also includes or has access to the files 410 and 420. The UE 110 requests (via one or more video requests 550) include a video request for 1 Mbps bit rate for epoch N and then a 0.5 Mbps bit rate for epoch N+1. In this example, both requests occur prior to the service entity 520 sending the video stream 460/450. In a conventional system without the video link adaptation process 525, the response 560 is sent responsive to the video request(s) 550. The response 560 includes the video stream 460 shown in FIG. 4. By contrast, with an exemplary embodiment of the instant invention, the video stream 450 is sent in response 570 to the video request(s) 550. As described above in reference to FIG. 4, the video stream 450 starts at 1 Mbps (portion 425), has an alternating pattern 430 that averages 0.75 Mbps, and ends at 0.5 Mbps (portion 435). Thus, there is a higher overall bit rate and less of a transition between epochs. As described above, the 1 Mbps video file 410 can be a 3-D video file, and the 0.5 Mbps video file 420 can be a 2-D video file. Reference numbers 451 and 452 are described below in reference to block 967 of FIG. 9.

FIG. 5 also illustrates that there could be a CDN1 530 that is off the operator network 510 or is a MO 180 with expensive processing power. The CDN1 530/MO 180 could then create a 0.75 Mbps video file 540 that could be used, e.g., for replacing the stream 460 with a video stream based on the created video file 540 and part of the response 560. However, as described above, the cost of equipment with this type of processing power is currently very expensive.

Regarding “Index (eNB ID X2, . . . ), or not listed if in origin server”, sometimes the intermediate compression level file may be available, but the intermediate compression level file may be available on a remote server, such that significant delay or costs are incurred in retrieving this file. Therefore an exemplary embodiment uses the locally available files instead of attempting to access the file 540.

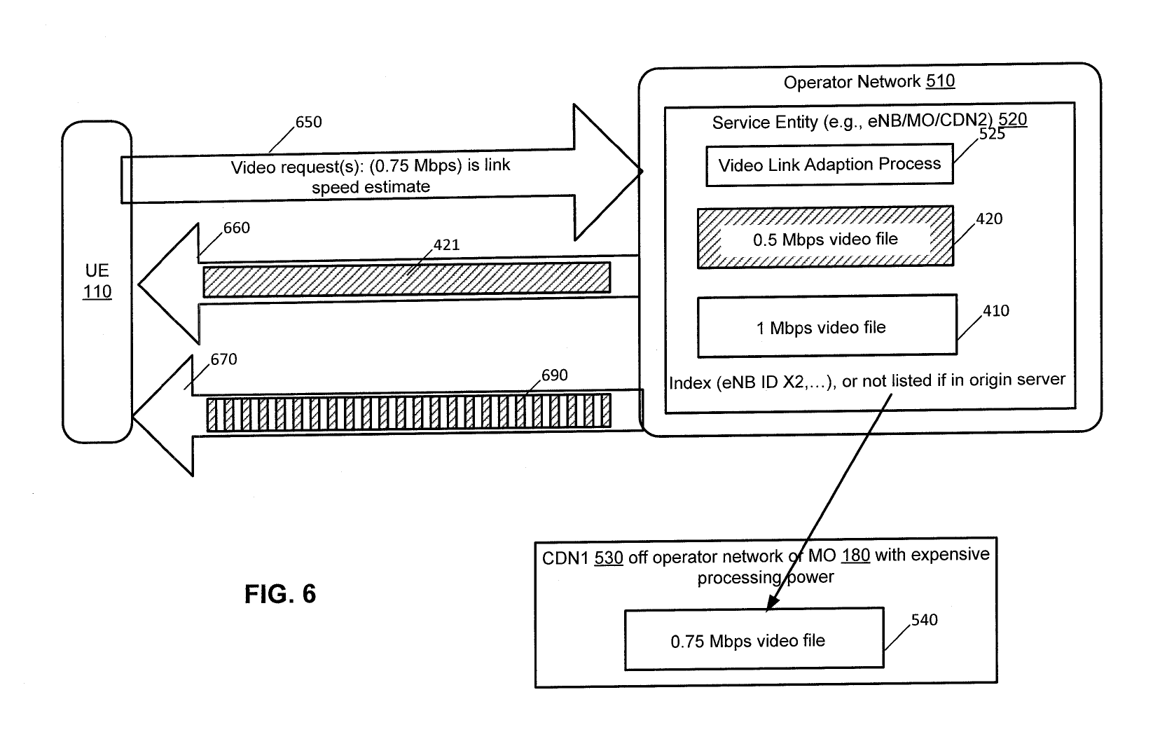

Referring now to FIG. 6, a block diagram is shown of exemplary system interactions using convention techniques and using an exemplary embodiment of the instant invention. Most of the elements in this example are described in reference to FIG. 5, so only the differences are described here. In this example, the video request(s) 650 include a request that 0.75 Mbps is the link speed estimate. A conventional technique is illustrated by response 660, where a 0.5 Mbps video stream 421 is sent. There is an unused wireless link capacity of 0.25 Mbps using the conventional techniques. In an exemplary embodiment herein, the video link adaptation process 525 therefore uses 50% (percent) GOPs from the 0.5 Mbps file 420 and 50% GOPs from the 1 Mbps video file 410 to create the alternating video stream 690, which therefore has a 0.75 Mbps bit rate. The alternating video stream 690 therefore fits the wireless link speed better than in the conventional response 660.

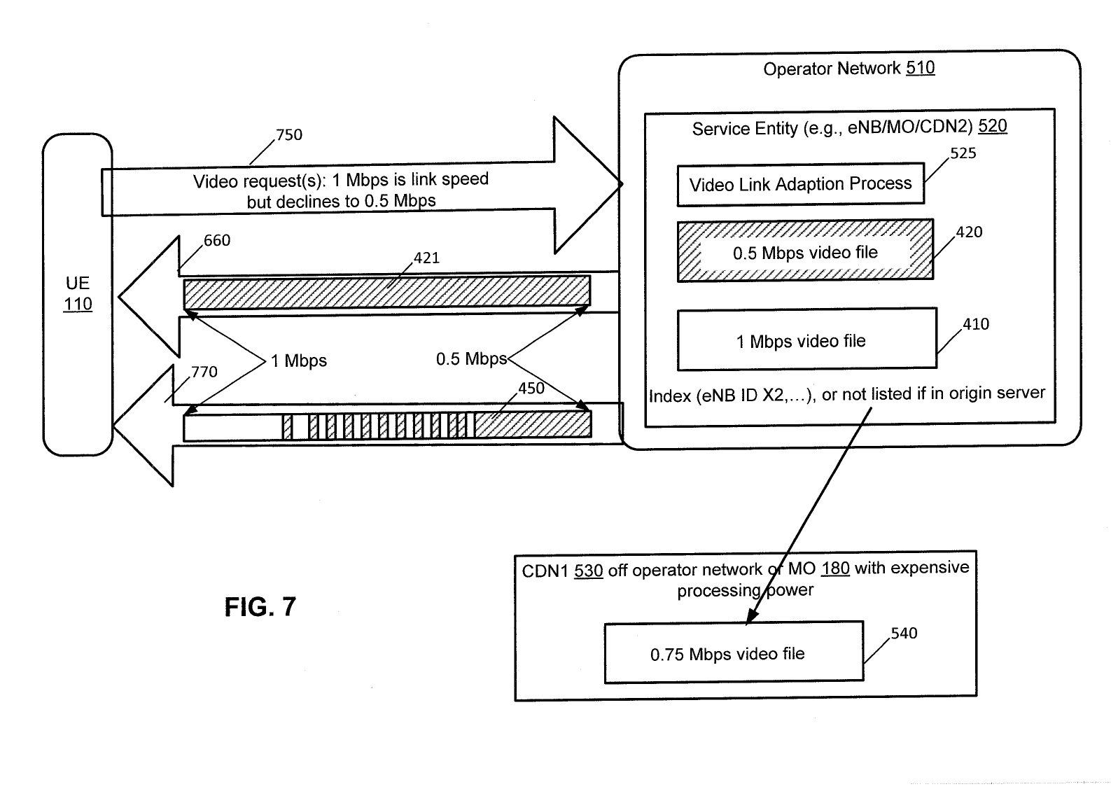

Turning to FIG. 7, a block diagram is shown of exemplary system interactions using convention techniques and using an exemplary embodiment of the instant invention. Most of the elements in this example are described in reference to FIGS. 5 and 6, so only the differences are described here. In the video request(s) 750, there is an initial request indicating 1 Mbps is the link speed, but the link speed then declines to 0.5 Mbps, e.g., via a another request. A conventional response 560 is to send a 0.5 Mbps video stream 421. An exemplary response 770 in accordance with an exemplary embodiment herein sends the stream 450, which starts at 1 Mbps and ends at 05. Mbps.

A nuanced point regarding, e.g., FIG. 7, is that when a service entity can take more time to reduce the video bit rate, then once the video stream being output reaches the bit rate corresponding to the current wireless link speed, the service entity may then “overshoot” the currently wireless link speed by then providing an even lower bit rate in the output video stream in order to compensate for the time interval when the service entity was sending video at a higher bit rate then the channel could allow.

Both FIGS. 6 and 7 illustrate that a CDN1 530 or MO 180 can create a 0.75 Mbps video file. It is noted that the examples of FIGS. 5-7 are applicable, for instance, to Apple live stream or Microsoft smooth stream and to straight PD (progressive download).

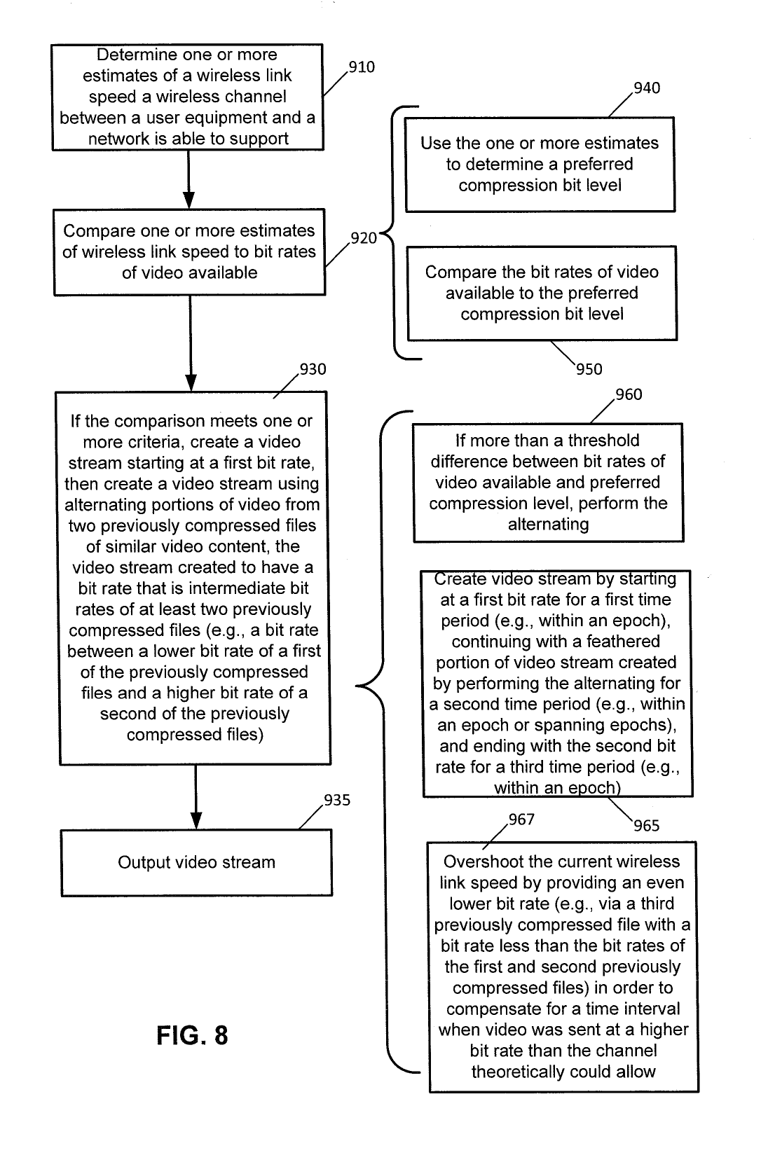

Turning now to FIG. 8, a block diagram is shown of a flowchart performed by, e.g., a service entity 520 in an operator network for storage and processing savings when adapting video bit rate to link speed. The operations in FIG. 8 may be method operations, operations performed by an apparatus, or operations performed by a computer program product. In block 910, the service entity 520 determine one or more estimates of a wireless link speed a wireless channel to a user equipment is able to support. In one example, the video requests 550/650/750 from the user equipment 110 may be used as the estimates of the wireless link speed. As noted above, TCP/IP acknowledgments may be used to estimate wireless link speed.

In block 920, the service entity 520 compares one or more estimates of wireless link speed to bit rates of video available. In block 930, the service entity 520 creates (e.g., if the comparison meets one or more criteria) a video stream using alternating portions of video from at least two previously compressed files of similar video content. Typically, each of the at least two previously compressed files is a compressed version of a single video (e.g., as described above in reference to FIG. 4. However, as also described above, there could be two views in video 410, each of which is one view of a single scene, in order to create a 3-D video. If the video 410 is 3-D, this version therefore could contain a compressed version of both views of single scenes from video 401. If the video 420 is 2-D, this version therefore could contain a compressed version of a single one of the two views of single scenes from video 401.

In one example, the video stream is created to have a bit rate intermediate bit rates of at least two previously compressed files. For instance, if there are three previously compressed files, the intermediate bit rate is somewhere between a highest and lowest bit rates of the three files. In another example, the video stream is created to have an intermediate bit rate between a lower bit rate of a first of the previously compressed files and a higher bit rate of a second of the previously compressed files. The intermediate bit rate is based on the one or more estimates of the wireless link speed a wireless channel between a user equipment and a network is able to support. The intermediate bit rate, as shown above, may be created by alternating and splicing together video GOPs from video of first and second previously compressed files to create the video stream having the intermediate bit rate. In particular, the video stream is created to fill at least a portion of an epoch, as shown in the figures described above. In block 935, the video stream is output (e.g., from a service entity 520 toward the UE 110). It is noted the video stream may be output as soon as, e.g., each GOP is ready. That is, there is no need to create an entire set of alternating GOPs, for instance, prior to outputting the GOPs.

FIG. 8 also illustrates a few more examples. In block 940, the one or more estimates of wireless link speed are used to determine a preferred compression level. In block 950, the bit rates of video available are compared to the preferred compression bit level. Typically, an estimate of the wireless link speed is used as the preferred compression level, but this depends on the scenario. For example, in the main examples used herein, if the wireless link speed is estimated to be 0.8 Mbps and the available video has bit rates of 0.5 Mbps and 1.0 Mbps, the preferred compression bit level may be set as 0.75 Mbps instead of 0.8 Mbps. In block 960, if there is more than a threshold difference between bit rates of video available and preferred compression level, the alternating is performed. As an example, blocks 940, 950, and 960 may be used so that when the system detects that the current link speed is much higher or much lower than (e.g., being a different by a threshold from) the current streaming bit rate, rather than immediately switching to the compression level corresponding to the new wireless link speed, the invention may be used to “feather” between files on a GOP basis in order to more smoothly move from the one bit rate to the next higher or lower bit rate. As another example, the bit rate transition created by feathering may be appropriate when a UE handoff is performed from a cell having a higher bit rate capability to another cell with a lower bit rate capability (or vice versa, handoff is performed from a cell having a lower bit rate capability to another cell with a higher bit rate capability).

Another example is illustrated by block 965. Block 930 concentrates mainly on feathering video using an alternating technique using two previously compressed files of different bit rates. Such feathering is shown in, e.g., video stream 690 of FIG. 6. However, as shown in FIGS. 5 and 7, it is also possible to combine the feathering of video with other portions of video that typically “sandwich” the feathered portion. This allows a service entity 520 to be able to start at one bit rate in a video stream, to proceed through a feathered portion of video in the video stream, and to end at a second bit rate in the video stream, e.g., over one or more epochs. Thus, in block 965, a service entity 520 creates a video stream by starting at a first bit rate for a first time period (e.g., within an epoch), continuing with a feathered portion of video stream created by performing the alternating for a second time period (e.g., within an epoch or spanning epochs), and ending with the second bit rate for a third time period (e.g., within an epoch). Examples of a video stream created using this technique are shown in FIGS. 4, 6, and 7 as video stream 450. Block 965 may start at a lower bit rate and end at a higher bit rate, or start at a higher bit rate and end at a lower bit rate. Additionally, three (or more) previously compressed files may be used to transition bit rate over one or more epochs. Further, block 965 may start at a first bit rate at the beginning of a first epoch and end with feathered video at the end of the first or a second epoch (thereby not having the final portion of video at the second bit rate for the third time period), or the reverse could also be true (block 965 may start with feathered video at the beginning of a first epoch and end with video at a first bit rate at the end of the first or a second epoch). Many other options are possible.

Yet another example is illustrated by block 967. When a service entity 520 can take more time to reduce the video bit rate, then once the bit rate corresponding to the current wireless link speed is reached via block 930, the service entity 520 may then overshoot the current wireless link speed by then providing an even lower bit rate (e.g., via a third previously compressed file with a bit rate less than the bit rates of the first and second previously compressed files) in order to compensate for the time interval when the service entity was sending video at a higher bit rate than the channel theoretically could allow. Returning to FIG. 5 as an example, reference 451 indicates a region where there is a bit rate in the video stream 450 that is technically higher than the estimated bit rate of 0.5 Mbps, since both 1 Mbps and 0.5 Mbps video is being alternated in this region. Region 452 could therefore contain an even lower bit rate video stream, based on a third previously compressed video file (not shown) having a bit rate of, e.g., 0.4 Mbps. The time in region 452 and the bit rate of the third compressed video file are selected, e.g., to compensate for a total bit rate above the 0.5 Mbps wireless link speed in order to reduce the overall bit rate of epoch N+1 (or a perhaps the portion 451 and 452) to about the 0.5 Mbps wireless link speed.

Turning to FIG. 9, a block diagram of a flowchart is shown that illustrates a more complex version of blocks 920 and 930 of FIG. 9. FIG. 9 assumes there is a lower bit rate file (e.g., 0.5 Mbps) and a higher bit rate file (e.g., 1.0 Mbps). In block 1010, a service entity streams a lower bit rate file in a current epoch if the wireless link speed estimate is within a first bit rate of the lower bit rate and the compression level served during the previous epoch was about the lower bit rate. Using the examples above, block 1010 may be implemented by streaming the 0.5 Mbps file if the wireless link speed estimate is less than 0.6 Mbps and the compression level served during the previous epoch was 0.5 Mbps.

In block 1020, the service entity streams the higher bit rate file in the current epoch if the wireless link speed estimate is within a second bit rate of the higher bit rate and the compression level served during the previous epoch was about the higher bit rate. For the examples above, block 1020 may be implemented by streaming the 1 Mbps file if the wireless link speed estimate is greater than 0.9 Mbps and the compression level served during the previous epoch was 1 Mbps.

In block 1030, the service entity performs an alternating pattern of the two files with the lower and higher bit rates if the wireless link speed estimate is about half way between the two bit rates and the wireless link speed achieved in the previous time period was in a predetermined range between the two bit rates. For the examples above, block 1030 may be performed by perform an alternating pattern of the two files throughout the epoch if the wireless link speed is about 0.75 Mbps and the wireless link speed achieved during the previous epoch was also between 0.6 and 0.9 Mbps.

In block 1040, the service entity performs an alternating pattern between the two files, transitioning from the bit rate provided in the previous epoch towards a preferred bit rate for the present epoch any time the preferred bit rate in the present epoch is greater than a threshold amount higher or lower than the bit rate provided in (e.g., at the end of) the previous epoch. Using the previous examples, block 1040 may be implemented by performing an alternating pattern between the two files, transitioning from the bit rate provided in the previous epoch towards the preferred bit rate for this epoch anytime the preferred bit rate in this epoch is greater than a threshold amount higher or lower than the bit rate provided (at the end) of the previous epoch. For example if the previous epoch provided 1 Mbps consistently, and in this epoch 0.5 Mbps is preferred, then an alternating pattern should be performed to transition from 1 Mbps down to 0.5 Mbps.

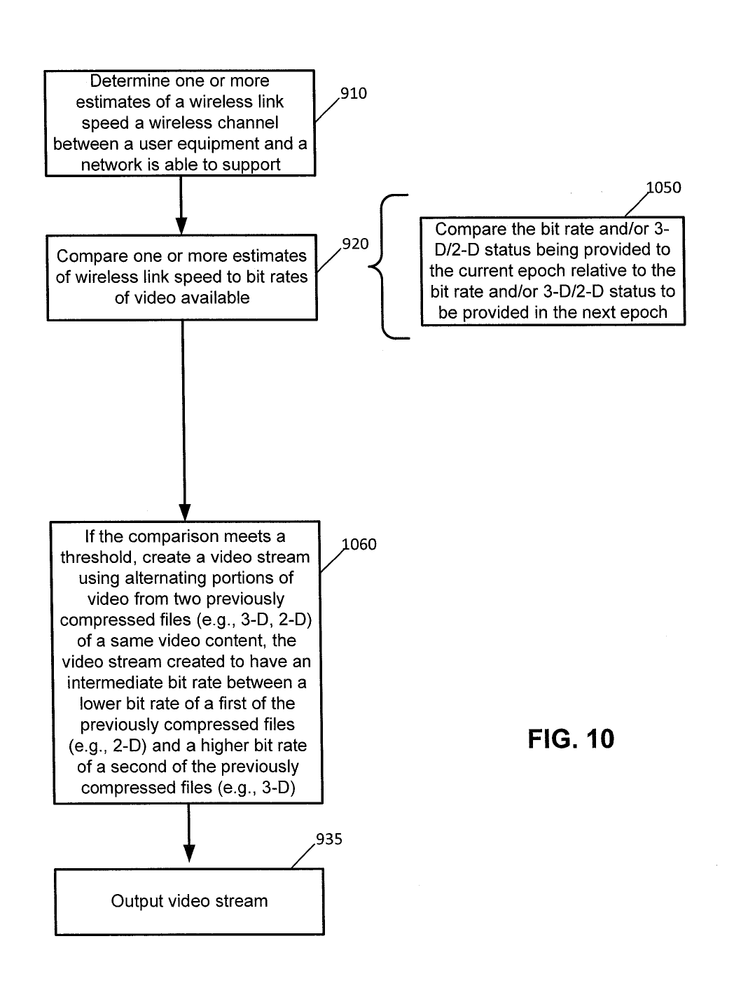

FIG. 10 shows another example of FIG. 8. In this example, in block 1050, the service entity compares the bit rate and/or 3-D/2-D status being provided to the current epoch relative to the bit rate and/or 3-D/2-D status to be provided in the next epoch. For instance, there may be instances where only 3-D/2-D status is relevant, and there may be other instances in which only the bit rate is relevant (as described above). And there may also be instances where a service entity 520 changes from 3-D to 2-D because, e.g., the wireless link speed only supports a bit rate suitable for 2-D. The 3-D and 2-D statuses are dimensional qualities of the video. In block 1060, if the comparison meets a threshold (e.g., a predetermined threshold for bit rate or change in 3-D/2-D status), the service entity creates a video stream using alternating portions of video from two previously compressed files (e.g., 3-D, 2-D) of a same video content, the video stream created to have an intermediate bit rate between a lower bit rate of a first of the previously compressed files (e.g., 2-D) and a higher bit rate of a second of the previously compressed files (e.g., 3-D).

The alternate three-dimensional/two-dimensional problem has to do with cases where the link speed goes down sufficiently far that the system decides that the overall quality would be better if the video stream was two-dimensional (e.g., better video quality is possible by giving up on the third dimension and using the little remaining bandwidth to provide adequate quality with just two dimensions). Given that the situation is detected, the alternating GOP between the two and three-dimensional files hopefully provide a lower bit rate mechanism for performing that segue without the segue being particularly jarring for the end user who is watching, while also not requiring significant processing to create a custom compression level file.

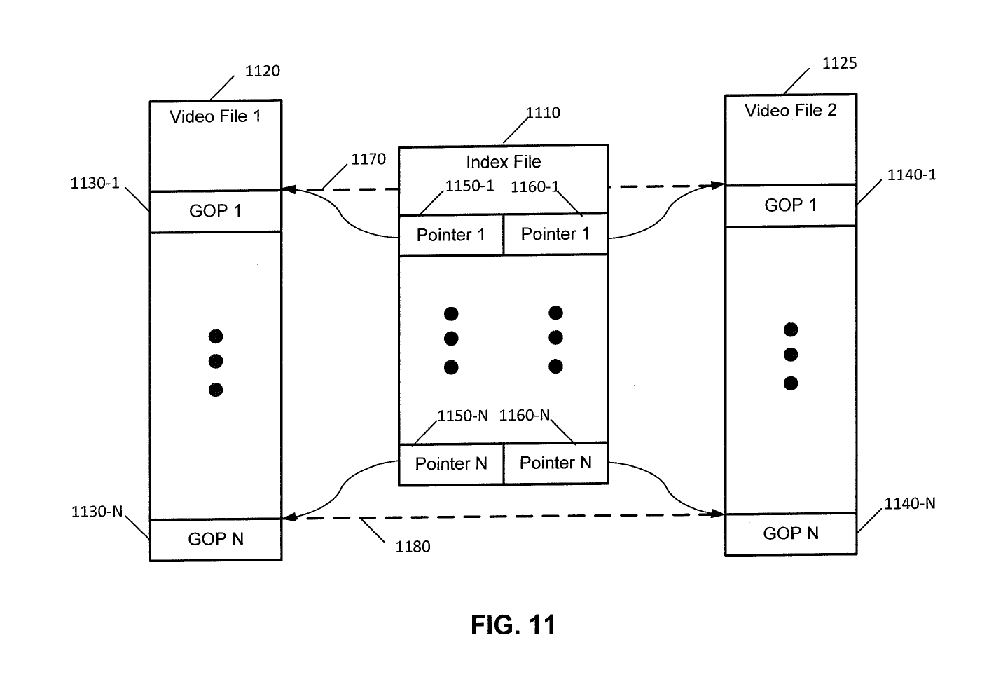

Referring now to FIG. 11, an example is shown of a mechanism suitable to use for alternating between two different files with two different bit rates. An index file 1110 has pointers 1150 pointing to the video file 1 1120 (e.g., a higher bit rate video file) and to video file 2 1125 (e.g., a lower bit rate video file). More specifically, the index file 1110 has pointers 1150-1 through 1150-N, each of which points to the beginning of each GOP 1130-1 to 1130-N in video file 1120. The index file 1110 further has pointers 1160-1 through 1160-N, each of which points to the beginning of each GOP 1140-1 to 1140-N in video file 1125. Furthermore, in an exemplary embodiment of this invention, the GOP boundaries in each of the files 1120, 1125 are aligned in order to enable this mechanism. The alignment of GOPs is illustrated by lines 1170 (for GOPs 1130-1 and 1140-1) and 1180 (for lines 1130-N and 1140-N).

It should be noted that the examples presented above mainly had a decreasing bit rate from one epoch to the next epoch. However, the bit rate could increase from one epoch to the next epoch, and the examples above would apply.

Furthermore, above, only two different bit rates were discussed. Nonetheless, the examples presented above are also applicable to higher numbers of bit rates. A sensible three video file example would be if one has three different video files available, at 1.5 Mbps, 1 Mbps, and 0.5 Mbps, and further in the previous epoch (or cell) the bit rate provided was consistently 0.5 Mbps, and the system just received an indication that the new preferred compression levels (based on a wireless link speed estimate) is 1.5 Mbps. In this case, it would appear appropriate to begin with mostly 0.5 Mbps GOPs and then incrementally include more and more 1 Mbps GOPs, and then as soon as one has completely phased out the 0.5 Mbps GOPs, the system would begin alternating in GOPs from the 1.5 Mbps file in addition to the existing 1 Mbps file's GOPs. In this example, the most interesting section may be right at the juncture between feathering between the first two files—and then shifting to feathering (e.g., alternating) between the second two files. So a pattern of BBAB..BCBB.. might be possible, where A represents the GOPs from the highest bit rate file, B represents the GOPs from the intermediate bit rate file, and C represents the GOPs from the lowest bit rate file.

Although the above exemplary embodiments concentrated on downlink (from a wireless network to a UE), the techniques may also be applied to uplink (e.g., from a UE to the wireless network).

The exemplary embodiments are applicable to (as non-limiting examples): multiple video protocols (HTTP-Progressive Download, HTTP-Adaptive streaming such as ALS and MSS); macro, pico and AWT architectures; and existing prototype efforts/collaborations.

Embodiments of the present invention may be implemented in software (executed by one or more processors), hardware (e.g., an application specific integrated circuit), or a combination of software and hardware. In an example embodiment, the software (e.g., application logic, an instruction set) is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted, e.g., in FIG. 3. A computer-readable medium may comprise a computer-readable storage medium (e.g., memory 325 or other device) that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1. A method, comprising:
creating a video stream using alternating portions of video from at least two previously compressed files of similar video content having one or both of differing bit rates or dimensional qualities, the video stream created to have a bit rate that is intermediate bit rates of the at least two previously compressed files, the intermediate bit rate based on one or more estimates of a wireless link speed over a wireless channel between a user equipment and a network; and
outputting the created video stream.

2. The method of claim 1, wherein the at least two previously compressed files have compressed versions of a same video.

3. The method of claim 1, wherein at least one of the at least two previously compressed files has a compressed version of multiple views of the same video scenes.

4. The method of claim 1, wherein creating the video stream is performed responsive to the one or more estimates of wireless link speed being a different by a threshold from a current streaming link bit rate.

5. The method of claim 1, wherein the one or more estimates are determined using one or more indications from the user equipment of the wireless link speed.

6. The method of claim 1, wherein the one or more estimates are determined based on a rate of transmission control protocol/Internet protocol acknowledgments received from the user equipment.

7. The method of claim 1, wherein creating comprises alternating and splicing together video groups of pictures from the at least two previously compressed files to create the video stream having the intermediate bit rate.

8. The method of claim 7, wherein:
the at least two previously compressed files comprise a first previously compressed file and a second previously compressed file;
the video stream is a first video stream;
the method further comprises:
creating a second video stream using one of the first or second previously compressed files;
creating a third video stream using an other of the first or second previously compressed files; and
outputting further comprises outputting the second video stream followed by the first video stream followed by the third video stream.

9. The method of claim 7, wherein the created video stream comprises consecutive groups of pictures comprising a first group of pictures from a first of the at least two previously compressed files, the first group of pictures preceded and followed by second groups of pictures from a second of the at least two previously compressed files.

10. The method of claim 7, wherein:
a first of the at least two previously compressed files has a lower bit rate relative to a higher bit rate for a second of the at least two previously compressed files;
the lower bit rate is a next lower value (NLV) of compression relative to the intermediate bit rate;
the higher bit rate is a next higher value (NHV) of compression relative to the intermediate bit rate;
the method further comprises determining a preferred compression (PC) bit rate based at least on the one or more estimates of the wireless link speed; and
the alternating pattern comprises [(PC-NLV)/(NHV-NLV)] percent of groups of pictures from the second previously compressed file and 1−[(PC-NLV)/(NHV-NLV)] percent of groups of pictures from the first previously compressed file.

11. The method of claim 7, wherein a rate of change of bit rate caused by the alternating and splicing is limited to a specific rate of change.

12. The method of claim 1, wherein the created video stream is used to transition from a first portion of a video stream at a first bit rate to a second portion of a video stream at a second bit rate, and wherein outputting further comprises outputting the first portion, the created video stream, and the second portion over one or two epochs.

13. The method of claim 1, wherein:
the video stream is a first video stream having for a first time period a bit rate above an estimate of the wireless link speed;
creating further comprises creating the first video stream using first and second ones of the at least two previously compressed files, the first previously compressed file having a lower bit rate relative to a higher bit rate for the second previously compressed file;
the method further comprises:
creating a second video stream using a third previously compressed file having a third bit rate lower than the bit rates of the first and second previously compressed files, wherein the third video stream is created for a second time period to reduce overall bit rate of the first and second video streams during the first and second time periods to about the estimate of the wireless link speed; and
outputting further comprises outputting the first and second video streams.

14. The method of claim 1, wherein:
creating further comprises creating the first video stream using first and second ones of the at least two previously compressed files;
for some portion of the created video stream, the creating is performed wherein there are more portions of video from one of the first or second previously compressed files than there are from an other one of the first or second previously compressed files.

15. The method of claim 1, wherein creating further comprises creating the first video stream using first and second ones of the at least two previously compressed files and wherein, for some portion of the created video stream, the creating is performed wherein there are equivalent portions of video from one of the first or second previously compressed files as there are from an other one of the first or second previously compressed files.

16. The method of claim 1, wherein the video stream is created to fill at least a portion of an epoch.

17. The method of claim 1, further comprising determining a preferred compression level based on at least the one or more estimates of the wireless link speed, and wherein creating is performed to cause the created video stream to have a bit rate determined using a bit rate of the preferred compression level.

18. The method of claim 17, wherein the creating is performed in response to the preferred compression level meeting one or more criteria relative to one or more of the lower or higher bit rates.

19. The method of claim 18, wherein the creating is performed to cause the created video stream to have a bit rate approximately a same as the bit rate of the preferred compression level.

20. The method of claim 1, wherein:
creating the video stream is performed responsive to a comparison of one of a three-dimensional or a two-dimensional status being provided in a current epoch relative to an other of the three-dimensional or the two-dimensional status to be provided in the next epoch indicating a change in status;
the first previously compressed file comprises a file comprising two-dimensional video; and
the second previously compress file comprises a file comprising three-dimensional video.

21-22. (canceled)
